(19) United States
(12) Patent Application Publication
(10) Pub. No.: US 2025/0111259 A1
(43) Pub. Date: Apr. 3, 2025

(54) PARAMETRIC FLUORESCENT READOUT FOR SUPERCONDUCTING QUBITS

(71) Applicant: Google LLC, Mountain View, CA (US)

(72) Inventor: Matthew James McEwen, Santa Barbara, CA (US)

(21) Appl. No.: 18/476,673

(22) Filed: Sep. 28, 2023

(51) Int. Cl. G06N 10/40

(52) U.S. Cl. CPC G06N 10/40

(57) ABSTRACT

The technology provides fluorescent readout of microwave-type qubits using a paracoupler architecture. A quantum computing system comprises a set of qubits configured to be responsive to one or more microwave signals and a control apparatus configured to apply the one or more microwave signals to the set of qubits. The control apparatus includes a set of control lines configured to transmit the one or more microwave signals to corresponding ones of the set of qubits. The system also includes a readout apparatus configured to perform qubit measurements. The readout apparatus including a readout line operatively coupled to the qubits. A paracoupler operatively arranged between the set of qubits and the readout apparatus is configured to enable parametric fluorescent readout of the qubits via the readout apparatus. When the paracoupler is not driven it prevents coupling of the qubits with the readout line.

### BACKGROUND

Quantum computers have the potential to provide fast solutions to certain classes of difficult problems. Multiple challenges in the design and implementation of quantum architecture to control, program and maintain quantum hardware impede the realization of large-scale quantum computing. Such challenges include efficient and accurate readout of information from the qubits of the quantum computer.

To read out the information stored in qubits, the qubits are first made to interact with an input signal. The interaction causes a response, which is used to provide information about the state of the qubits. In order to provide such information, the response is read out from the qubits using a measurement and readout system. Where a qubit has more than two energy states, states with more energy than the lowest two (leakage states) may be inadvertently populated by various operations, which is called leakage. One approach employs dispersive readout. While suitable in certain architectures, this approach may not effectively handle higher qubit energy states. It can be slow and is susceptible to high error rates. In particular, dispersive readout may cause leakage via the process of readout ionization, where the microwave drive used to induce dispersive readout supplies energy of the leakage states of the qubit. Dispersive readout may require additional structures, such as a Purcell filter, to prevent qubit state destruction during readout. Moreover, it may require large photon numbers to be driven through the readout line, and thus can cause large transitions that may destroy the qubit state via readout ionization.

### BRIEF SUMMARY

According to aspects of the technology, a microwave circuit-based quantum computing architecture employs parametric coupling for effective readout. The technology provides fast and scalable readout of superconducting qubits, which has the added technical benefits of removing leakage and avoiding readout ionization. The system can employ a paracoupler in various configurations to achieve parametric fluorescent readout of the superconducting qubits. This is done by driving the qubit in a specific way to cause a parametric interaction. The paracoupler may be configured as a shaped metal element arranged between the qubit and the readout line of the quantum computing apparatus.

According to one aspect of the technology, a quantum computing system is provided. The system comprises: a set of qubits configured to be responsive to one or more microwave signals; a control apparatus configured to apply the one or more microwave signals to the set of qubits, the control apparatus including a set of control lines configured to transmit the one or more microwave signals to corresponding ones of the set of qubits; a readout apparatus configured to perform one or more measurements on the set of qubits, the readout apparatus including a readout line operatively coupled to the set of qubits; and a paracoupler operatively arranged between the set of qubits and the readout apparatus, the paracoupler being configured to enable parametric fluorescent readout of the qubits via the readout apparatus, wherein when the paracoupler is not driven the paracoupler prevents coupling of the qubits with the readout line.

In one scenario, the quantum computing system further comprises a capacitor operatively arranged between the paracoupler and the readout line of the readout apparatus. A frequency at the readout line may be chosen in accordance with a frequency associated with the paracoupler and a frequency associated with one or more of the set of qubits. Here, the frequency at the readout line may be in the microwave band. In an example, the capacitor provides a selected kappa level. The quantum computing system may further comprise a resonator operatively arranged between the paracoupler and the capacitor. In this case, the resonator may have a given operating frequency, and the paracoupler is an LR parametric drive configured to couple a first qubit frequency to the operating frequency of the resonator and to not couple a second qubit frequency to the operating frequency of the resonator.

In another scenario, the quantum computing system further comprises a resonator operatively arranged between the paracoupler and the readout line of the readout apparatus. Here, the paracoupler may be a first paracoupler, and the quantum computing apparatus may further include a second paracoupler operatively arranged between resonator and the readout line of the readout apparatus.

Alternatively or additionally to any of the above, the one or more microwave signals may comprise a set of microwave control pulses. In this case, one or more of the set of microwave control pulses may comprise a x-pulse, which acts to exchange populations of quantum states in the one or more qubits.

According to another aspect of the technology, a quantum computing method is provided that comprises: applying one or more microwave signals, by a control apparatus of a quantum computing system via a set of control lines, to selected ones of a set of qubits of the quantum computing system; enabling, by a paracoupler operatively arranged between the set of qubits and a readout apparatus, parametric fluorescent readout of the qubits, wherein when the paracoupler is not driven the paracoupler prevents coupling of the qubits with a readout line of the readout apparatus; and performing, by the readout apparatus via the readout line, one or more measurements on the set of qubits based on the applied one or more microwave signals and the enabling of the paracoupler.

The one or more microwave signals may comprise a set of microwave control pulses. Here, one or more of the set of microwave control pulses may comprise a x-pulse, which acts to exchange populations of quantum states in the one or more qubits.

In one scenario, a capacitor is operatively arranged between the paracoupler and the readout line of the readout apparatus, in which the capacitor provides a selected kappa level. A frequency at the readout line may be chosen in accordance with a frequency associated with the paracoupler and a frequency associated with one or more of the set of qubits. The frequency at the readout line may be in the microwave band.

In another scenario, a capacitor is operatively arranged between the paracoupler and the readout line of the readout apparatus and a resonator is operatively arranged between the paracoupler and the capacitor, the resonator having an operating frequency. In this case, the paracoupler may be an LR parametric drive configured to couple a first qubit frequency to the operating frequency of the resonator and to not couple a second qubit frequency to the operating frequency of the resonator.

In a further scenario, a resonator is operatively arranged between the paracoupler and the readout line of the readout apparatus. Here, the paracoupler may be a first paracoupler, and the quantum computing apparatus may further include a second paracoupler operatively arranged between resonator and the readout line of the readout apparatus.

### BRIEF DESCRIPTION OF THE DRAWINGS

FIG. 1 illustrates an example quantum processing unit arrangement in accordance with aspects of the technology.

FIGS. 2A-B illustrate a dispersive readout approach for a quantum computing system.

FIGS. 3A-B illustrate a paracoupling example in accordance with aspects of the technology.

FIGS. 4A-B illustrate another paracoupling example in accordance with aspects of the technology.

FIGS. 4C-D illustrate a further paracoupling example in accordance with aspects of the technology.

FIGS. 5A-B illustrate an LR parametric drive example in accordance with aspects of the technology.

FIGS. 6A-B illustrate fluorescent readout in accordance with aspects of the technology.

FIGS. 7A-B illustrate a readout example according to a first qubit state in accordance with aspects of the technology.

FIGS. 8A-B illustrate a readout example according to a second qubit state in accordance with aspects of the technology.

FIGS. 9A-B illustrate transitions between Jaynes-Cummings energy levels in accordance with aspects of the technology.

FIG. 10 illustrates additional transitions between Jaynes-Cummings energy levels in accordance with aspects of the technology.

FIGS. 11A-B illustrate simulations of qubit states in accordance with aspects of the technology.

FIGS. 12A-C illustrate additional simulations of qubit states in accordance with aspects of the technology.

FIG. 13 illustrates a dual paracoupler configuration for entanglement readout in accordance with aspects of the technology.

FIG. 14 illustrates a method in accordance with aspects of the disclosure.

### DETAILED DESCRIPTION

### Overview

Aspects of the technology provide fluorescent readout of microwave-type qubits using a paracoupler architecture. As explained herein, a parametric drive (or “para drive”), such as a leakage removal (LR) parametric drive, selectively couples particular frequency states to the resonator frequency. This results in only desired signals being sent or applied to the system readout line. This approach avoids the need for a Purcell filter at the readout line. In some configurations, the parametric drive is implemented as a qubit-resonator paracoupler. Here, because the resonator is not driven, the system does not need to drive the readout line, which can simplify the system architecture. In other configurations, a resonator may be omitted entirely from the readout module.

### Example Implementations

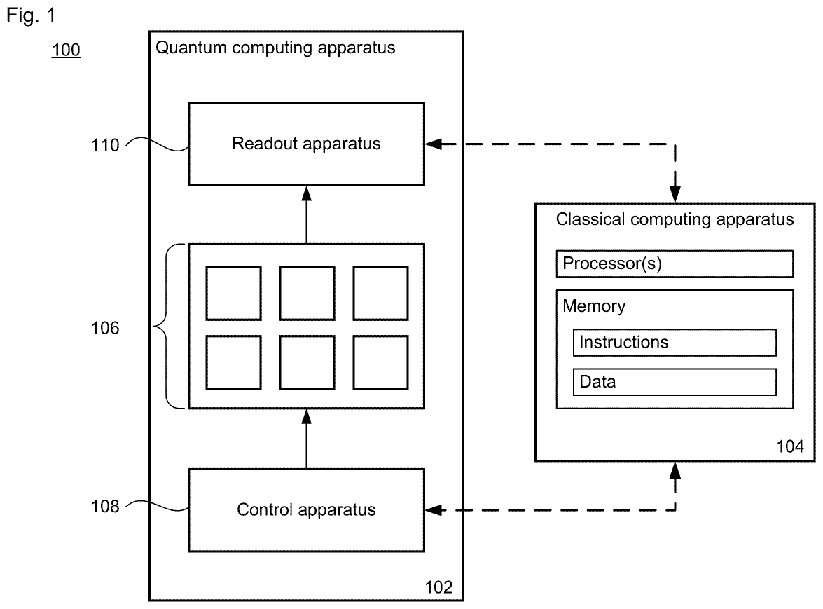

FIG. 1 shows an overview of an exemplary quantum computing system 100. The system comprises a quantum computing apparatus 102 and a classical computing apparatus 104. The quantum computing apparatus 102 comprises one or more physical qubits 106, which can be used to perform quantum processing for various tasks and operations. In the example shown, six qubits 106 are present, although more or fewer qubits can be used. Each qubit 106 is a physical system with three or more quantum levels. Two of the quantum levels are taken to form the computational subspace, e.g., the states |0 [symbol] and |1 [symbol] . These may, in some implementations, be the lowest two energy states of the physical system being used as a qubit. The remaining one or more states form the non-computational (or leakage) subspace, e.g., |2 [symbol] , |3 [symbol] etc.

As an example, f₀₁ refers to a difference in frequency between the states |0 [symbol] and |1 [symbol] . Note that the frequency of two qubits can be offset by qbit anharmonicity.

In some implementations, the qubits 106 may be microwave superconducting qubits that can be responsive to applied microwave signals. For example, the qubits 106 may be transmon-type qubits. Alternatively, the qubits may be of other types, such as gmon, fluxmon, fluxonium, or capacitively-shunted flux. In still other implementations other semiconductor-based qubit architectures may be used instead, such a system based on quantum dots and spin qubits.

The quantum computer further comprises a control apparatus 108. The control apparatus 108 is configured to apply control signals to one or more the qubits 106 in order to alter a state or property of the qubits. For example, the control apparatus 108 can apply control signals to the qubits 106 in order to implement one or more quantum gates on the qubits 106. The control apparatus 108 may include a set of one or more control lines for transmitting control signals to the one or more qubits 106. The control signals may, for example, comprise control pulses for altering states on the one or more qubits 106. Such control pulses may be, e.g., in the form of microwave control pulses. An example of such a microwave control pulse is a x-pulse, which acts to exchange the populations (e.g., the amplitudes) of quantum states in the one or more qubits 106.

As shown, the quantum computer further includes a readout apparatus 110. The readout apparatus 110 is configured to perform measurements on the one or more qubits 106. Performing measurements involves sending a signal into the system and receiving a signal out of the system, where the received signal is shifted in phase or amplitude based on the qubit state. Thus, based on the results of the measurements, the readout apparatus 110 provides output indicative of the state of the one or more qubits 106. For example, the readout apparatus 110 may provide an output of “0” or “1” corresponding to the |0 [symbol] and |1 [symbol] states of the qubit respectively for each of the qubits in the assembly. As another example, the readout apparatus 110 may provide an output of “00”, “01”, “10”, or “11” corresponding to the 2-qubit |00 [symbol] , |01 [symbol] , |10 [symbol] and |11 [symbol] states of the qubit respectively. As shown, the readout apparatus 110 is a separate component to the control apparatus 106. However, in other implementations the readout apparatus 110 may be a part of the control apparatus 108.

The classical computing apparatus 104 may interact with the control apparatus 108 to control operation of the control apparatus 108. For example, a user interface for the control apparatus 104 (not shown) may be provided through the classical computing apparatus 104. The classical computing apparatus 104 may also process measurement data/readout states from the readout apparatus 110 to determine properties of the qubits 106, such as the average population of quantum states.

As shown, the classical computing apparatus 104 includes one or more processors and memory that is configured to store instructions and data. The processors may be any conventional non-quantum computing processors, such as commercially available CPUs, TPUs, graphical processing units (GPUs), etc. Alternatively, each processor may be a dedicated device such as an ASIC or other hardware-based processor. The memory may be of any type capable of storing information accessible by the processor(s), including a computing device-readable medium. The memory is a non-transitory medium such as a hard-drive, memory card, optical disk, solid-state, etc.

Although FIG. 1 functionally illustrates the processor(s) and memory as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system. Accordingly, references to a processor or computing device of the classical computing apparatus will be understood to include references to a collection of processors or computing devices or memories that may or may not operate in parallel.

Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

### Dispersive Readout

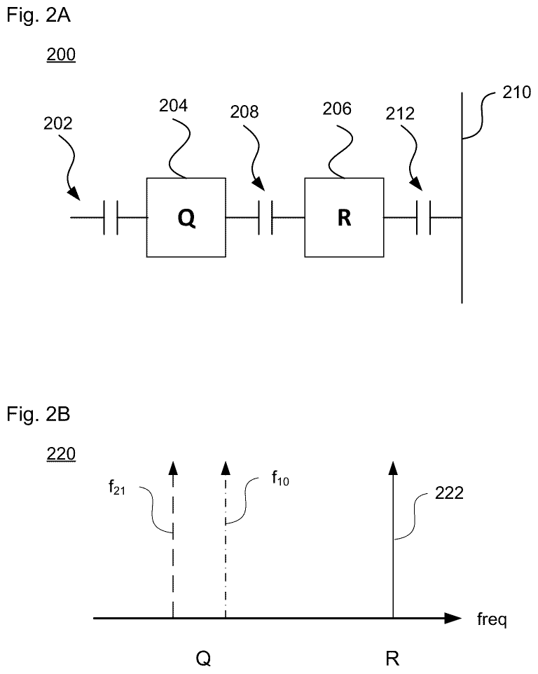

FIGS. 2A and 2B illustrate an example involving dispersive readout. FIG. 2A presents a circuit 200 for dispersive readout. As shown, there is a drive line 202 into qubit 204, which is coupled to resonator 206 via a capacitor 208. The drive line 202 may include a capacitor as illustrated. The resonator couples to readout line 210 via another capacitor 212. The capacitor 212 may have, by way of example only, a kappa of around 1/(30-50 ns), which corresponds to a physical dimension in the 10-100 um range (depending on the geometry). In this configuration, if there is a photon in the resonator, it quickly leaves the readout line 210. In particular, photons at the resonator frequency leave into the readout line, and that is detected by the readout apparatus to finish the readout. Moreover, in this approach the readout line 210 typically needs to be complex, and may require use of a Purcell Filter. FIG. 2B illustrates a plot 220 with an arrangement of frequencies, which may occur when using the circuit 200. In this example, the qubit 204 has −ve nolinearity, in which f₂₁ is below f₁₀, while the resonator frequency 222 is above those of the qubit. Nonlinearity is the difference in the energy level spacing between the 01 and 12 transitions. The 01 transition is the energy difference between 0 and 1 states. In some qubits, such as transmons, the nonlinearity is a negative number, i.e., the 21 transition would be lower than the 01 transition.

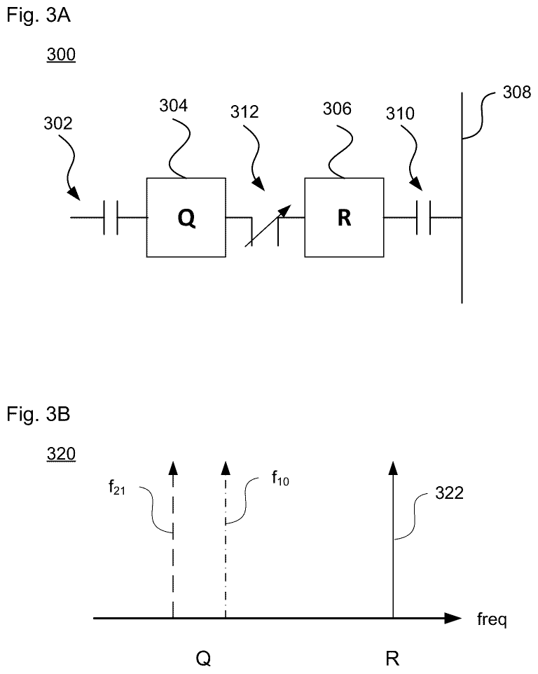

FIGS. 3A and 3B illustrate a paracoupling example in accordance with aspects of the technology. FIG. 3A presents a circuit 300 for parametric fluorescent readout. As shown, there is a drive line 302 into qubit 304. Resonator 306 couples to readout line 308 via a capacitor 310. The drive line 302 may include a capacitor as illustrated. In this arrangement, a paracoupler 312 is arranged between the qubit 304 and the resonator 306. FIG. 3B illustrates a plot 320 with an arrangement of frequencies, which may occur when using the circuit 300. In this scenario, when the paracoupler 312 is not driven, it prevents coupling with the readout line 308. In other words, it acts as an open circuit between the qubit 304 and the resonator 306. In this configuration, because the qubit 304 cannot see the readout line at all, no Purcell filter is needed for readout. The paracoupler 312 is configured to selectively couple different energy levels of the qubit 304 to the readout line 308. For instance, when the qubit is in the |2 [symbol] state, it may be mapped onto the resonator (and then to the readout line). This approach allows one photon to go through, thereby providing a very accurate readout. The “fluorescent” aspect of the readout is akin to a chemical process in which a high-frequency illumination interacts with specific transitions in an atom to produce lower frequency light.

As noted above, the paracoupler may be configured as a shaped metal element, which in this configuration is arranged between the qubit 304 and the resonator 306. In one example, the spacing between the paracoupler and the qubit should be equivalent to the spacing between the paracoupler and the resonator. For instance, if there is approximately 1 mm of spacing between the qubit and the paracoupler, there may be approximately 1 mm of spacing between the paracoupler and the resonator. Such spacings may vary, which may depend on the side of the qubit and/or the size of the resonator. Thus, in this case the qubit may be 1 mm wide and the resonator may be 1 mm long. The spacings may vary by up to a threshold amount, e.g., 10-15% spacing variance.

The metal may be configured to have a particular geometric shape so that the circuit can achieve parametric fluorescent readout. The operation of the circuit, including the frequencies actually achieved, is geometry dependent. Here, the specific shape of a coupler may determine how effective it is; however, any shape that achieves the desired frequencies is suitable. According to one aspect of the technology, from a material properties perspective, the metal that makes up the paracoupler is superconducting. The qubits and resonator are also superconducting.

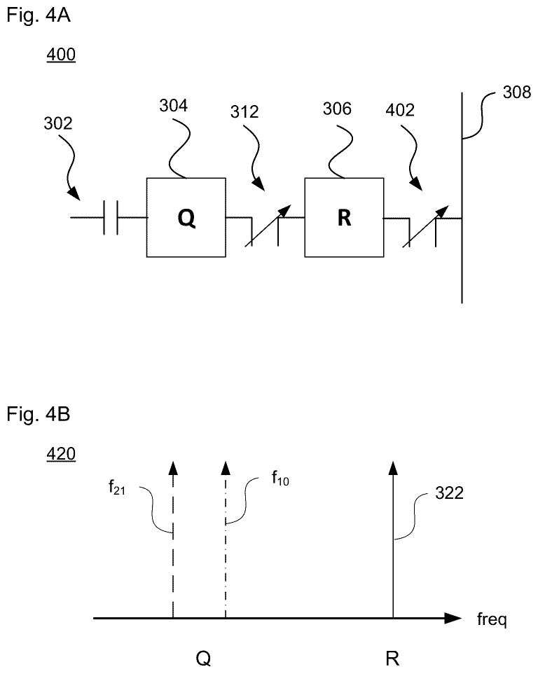

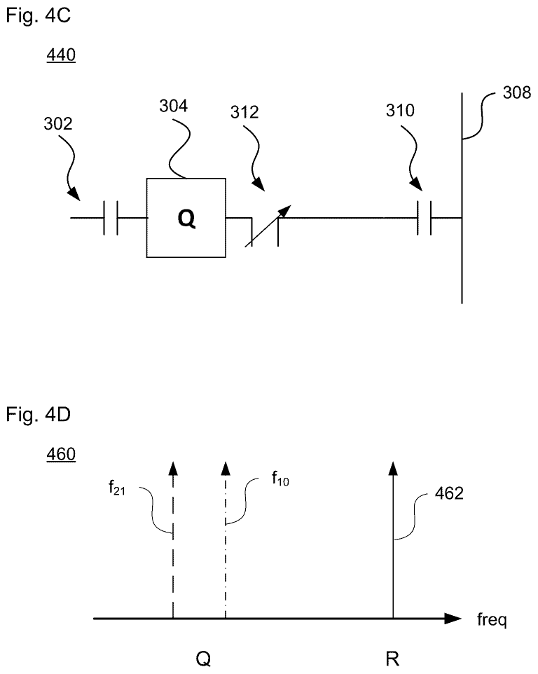

FIGS. 4A and 4B illustrate another paracoupling example in accordance with aspects of the technology. FIG. 4A presents a circuit 400 for parametric fluorescent readout. As with the example of FIG. 3A, there is a drive line 302 into qubit 304. The drive line 302 may include a capacitor as illustrated. Similarly, paracoupler 312 is arranged between the qubit 304 and the resonator 306. However, in this case resonator 306 couples to readout line 308 via another paracoupler 402. FIG. 4B illustrates a plot 420 with an arrangement of frequencies, which may occur when using the circuit 400. As with FIG. 3B, when the paracoupler 312 is not driven, it prevents coupling with the readout line 308. In other words, it acts as an open circuit between the qubit 304 and the resonator 306. In this configuration, because the qubit 304 cannot see the readout line at all, no Purcell filter is needed for readout. As with the configuration of FIG. 3A, the paracoupler 312 is configured to selectively couple different energy levels of the qubit 304 to the readout line 308. Here, the second paracoupler 402 allows even larger kappas and enables adaptive frequency selection.

Kappa corresponds to the coupling between the resonator and an external readout line of the readout apparatus or of the classical computing apparatus. During the readout, this coupling provides the readout signal to the readout line. When readout is not occurring, the value of kappa is not important. By way of example, a capacitor gives a kappa value that is fixed over time. A paracoupler would give a kappa that can be “activated” by applying a paradrive, and so can be activated to the same extent as that induced by a capacitor. However, using a paracoupler here provides additional degrees of freedom, such as the signal in the readoutline being able to be a different frequency from the resonator frequency.

FIGS. 4C and 4D illustrate a further paracoupling example in accordance with aspects of the technology. FIG. 4C presents a circuit 440 for parametric fluorescent readout. As with FIG. 3A, there is the drive line 302 into qubit 304. The drive line 302 may include a capacitor as illustrated. In this configuration, the resonator is omitted, so paracoupler 312 is arranged between the qubit 304 and the capacitor 310 that couples to the readout line 308. Similar to FIGS. 3B and 4B, FIG. 4D illustrates a plot 460 with an arrangement of frequencies, which may occur when using the circuit 440. In this scenario, as above, when the paracoupler 312 is not driven, it prevents coupling with the readout line 308. In other words, it acts as an open circuit between the qubit 304 and the readout line 308. Arrow 462 represents the target frequency on the readout line 308. According to one aspect of the technology, without a resonator, the frequency 462 in the readout line is chosen in accordance with the paradrive frequency and the qubit frequency. There is freedom to vary that frequency by changing the paradrive. In many situations, the target frequency may be a frequency in the microwave band around the same as the frequency that a resonator would be at.

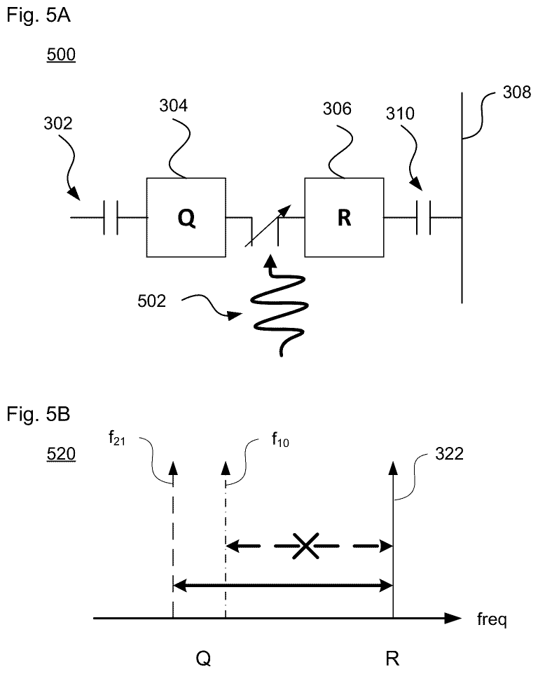

FIGS. 5A-B illustrate an LR parametric drive approach according to aspects of the technology. As shown in view 500 of FIG. 5A, this approach employs the architecture of FIG. 3A. However, the LR parametric drive approach can also be used with the other architectures discussed here. Here, the paracoupler is an LR parametric drive 502, which is configured to selectively couple f₂₁ to the frequency of the resonator 306. Moreover, the LR parametric drive 502 is configured to not couple f₁₀ to the resonator frequency. The coupling of f₂₁ (solid double arrow) and the non-coupling of f₁₀ (dashed double arrow and “X”) are shown in view 520 FIG. 5B. This means that the paracoupler is configure to send {Qubit in |2 [symbol] Res in |0 [symbol] } to {Qubit in |1 [symbol] Res (resonator) in |1 [symbol] }, while doing nothing to Qubit in |1 [symbol] Res in |1 [symbol] . Note that Res rapidly goes to |0 [symbol] because of kappa. By way of example, the LR parametric drive may be implemented by room temperature (or otherwise non-superconducting) electronics and a drive line (e.g., a conductive wire) brings signals to the paracoupler. The room temperature electronics may comprise a controllable source of microwave range electrical signals. By way of example, this may include digital to analog converters (DACs) mixers, amplifiers and/or attenuators. An alternative parametric drive strategies include driving the qubit(s) using multiple drive pulses and using a fixed capacitor instead of a paracoupler; however, the string coupling of the qubit to the resonator in this approach may give the qubit a short lifetime, as it decays into the resonator during operations. In contrast, the paracoupler prevents this as it does not induce a coupling when it is not being driven.

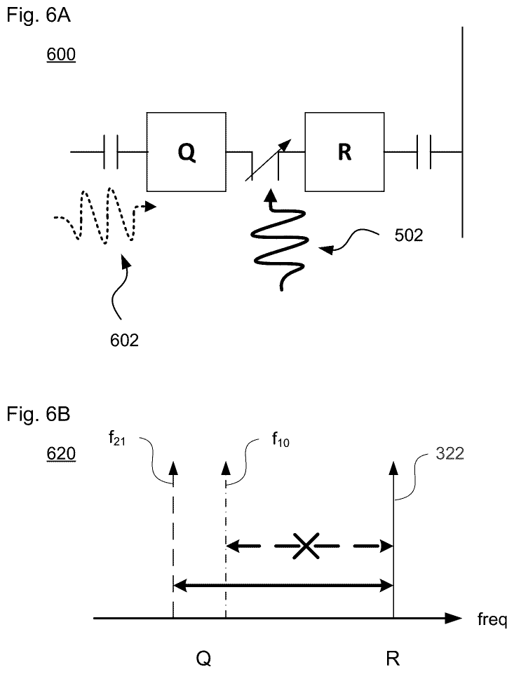

FIGS. 6A-B illustrate an example of fluorescent readout when using the LR parametric drive approach discussed above. As shown in view 600 of FIG. 6A, the system drives f₂₁, but not f₁₀, via the drive line 302 into qubit 304. View 620 of FIG. 6B shows the selective coupling as in FIG. 5B. According to one aspect of the technology, the selective parametric drive is achieved by the paradrive 502. The fast decay means having a large kappa, which can be achieved by having a capacitor or a driven paracoupler (or indeed any other way of coupling the resonator to the readout line).

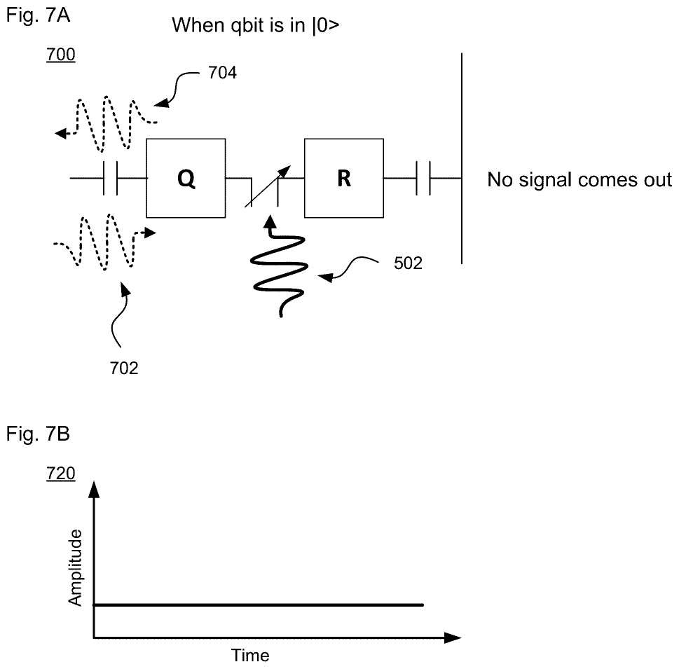

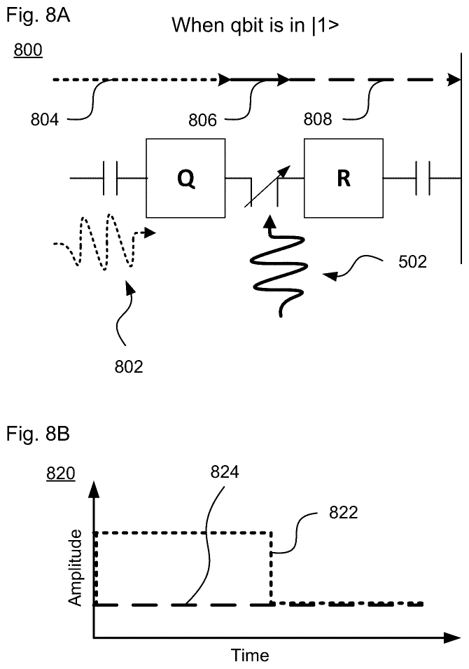

FIGS. 7A-B show what happens when the qubit is in |0 [symbol] , and FIGS. 8A-B show what happens when the qubit is in |1 [symbol] . In particular, in view 700 of FIG. 7A, the system drives f₂₁ onto the drive line 302 as shown at 702. Here, the drive reflects off of the qubit in |0 [symbol] , as shown by reflection 704. No signal is output on the readout line. This is shown in plot 720 of FIG. 7B, where the amplitude out of the readout line does not change over time. In contrast, as shown in view 800 of FIG. 8A and view 820 of FIG. 8B, when the qubit is in |1 [symbol] and f₂₁ is driven, this pushes qubit |1 [symbol] to |2 [symbol] . Here, dotted arrow 804 corresponds to f₂₁ being driven to the qubit, solid arrow 806 corresponds to the LR parametric drive moving one photon from the qubit to the resonator, and dashed arrow 808 corresponds to the photon leaving into the readout line. In FIG. 8B, the amplitude out of the readout line is shown changing over time, either according to driven f₂₁ (dotted line 822) or the photon moving into the resonator (dashed line 824).

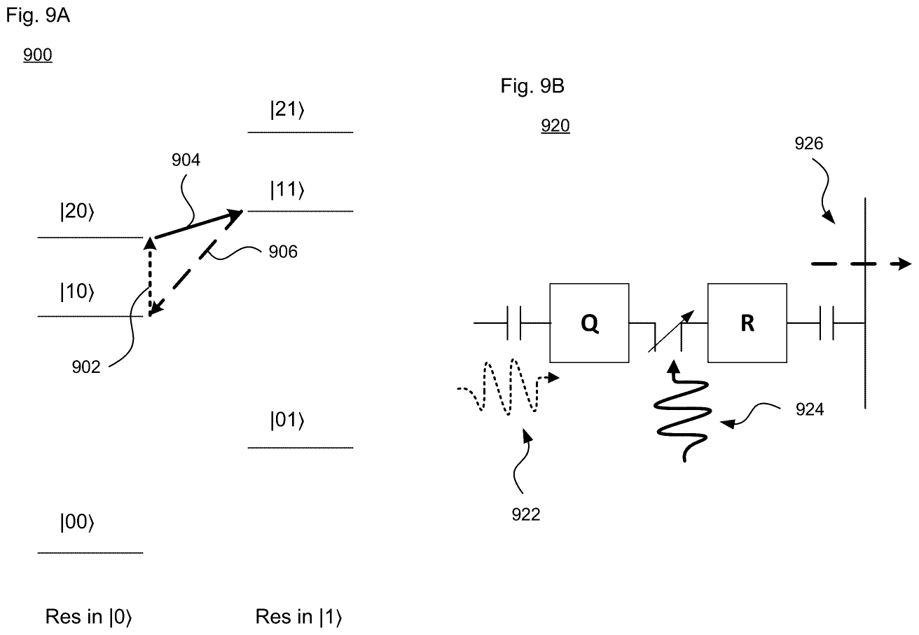

FIGS. 9A-B illustrate a scenario showing transitions between Jaynes-Cummings energy levels when an LR parametric drive architecture is employed. FIG. 9A illustrates view 900, presenting Jaynes-Cummings energy levels, with the left side showing the resonator in |0 [symbol] and the right side showing the resonator in |1 [symbol] . The different arrows represent the driven transitions between levels, and correspond to the different parts of the architecture shown in view 920 of FIG. 9B. In particular, f₂₁ is driven from |10 [symbol] to |20 [symbol] as shown at 902, corresponding to when the system drives f₂₁ onto the drive line as illustrated at 922 in FIG. 9B. Then the LR parametric drive causes a transition from |20 [symbol] to |11 [symbol] as shown at 904, corresponding to 924 in FIG. 9B, in which the parametric drive sends an extra photon to cause readout. Then the energy level transitions from |11 [symbol] to |10 [symbol] at readout as shown at 906, corresponding to 926 in FIG. 9B. As the process goes through one circuit through the f₂₁, parametric drive and readout transitions, one photon of signal is obtained via the readout line.

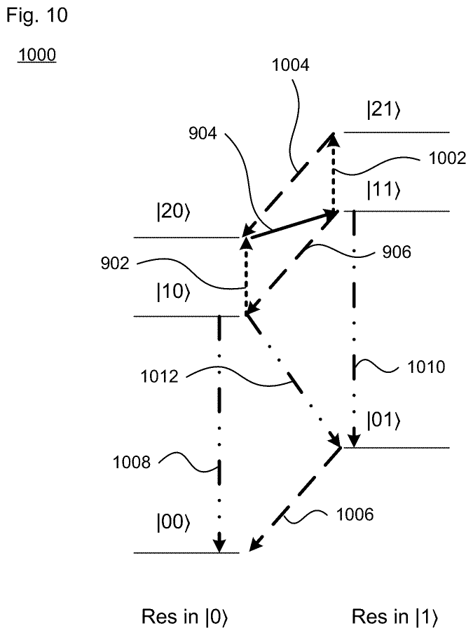

View 1000 of FIG. 10 illustrates other possible transitions associated with operation of the LR parametric drive and with readout, which include situations that can introduce errors at readout of the qubit state. Here, a transition from |11 [symbol] to |21 [symbol] is shown with dotted arrow 1002, along with a transition from |21 [symbol] to |20 [symbol] as shown with dashed arrow 1004. There is also a transition from |01 [symbol] to |00 [symbol] as shown with dashed arrow 1006. These transitions within the loop encompassing |10 [symbol] , |20 [symbol] , |11 [symbol] , and |21 [symbol] at are not problematic. However, if the drives producing the transitions 902 or 1002 are not selective enough, a primary error process involves dropping out of the loop. In particular, there may be a transition from |10 [symbol] to |00 [symbol] (dash-dot arrow 1008) or from |11 [symbol] to |01 [symbol] (dash-dot arrow 1010). Such transitions are referred to as off resonance transitions. Here, the qubit could naturally lose a photon (referred to as T1 decay). Moreover, there may be a transition from |10 [symbol] to |01 [symbol] (dash-dot arrow 1012), which can be caused when the drive producing the transition from |11 [symbol] to |01 [symbol] is not selective enough.

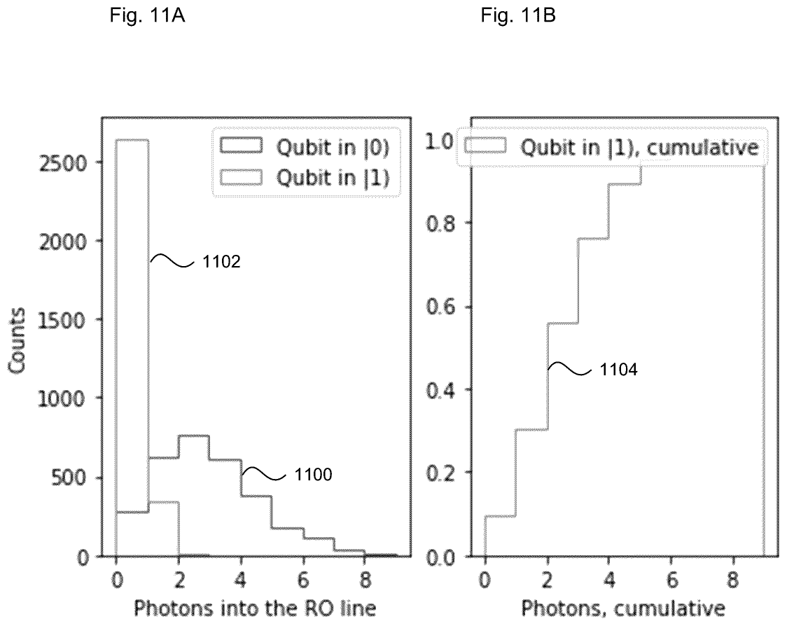

FIGS. 11A-B illustrate Monte Carlo simulation of qubit states when using a paracoupler such as in the configurations described above. In particular, FIG. 11A plots counts (Y-axis) to photons in the readout line (X-axis) for both a qubit in |0 [symbol] (line 1100) and the qubit in |1 [symbol] (line 1102). FIG. 11B illustrates the cumulative number of photons (X-axis) when the qubit is in |1 [symbol] , as shown by line 1104. These simulations did not use a preexisting technique to make the drives more selective. With respect to FIG. 11A, ideally there should be almost no photons in |0 [symbol] , and should be around 10 photons in in |1 [symbol] . For the simulation, readout was run 10,000 times for a qubit starting in 0 and for 1. Counts (Y-axis) refers to how many of those runs were received a given number of photons out. The error of this readout process is given by the overlap of the two curves of FIG. 11A, which can be seen to be quite low.

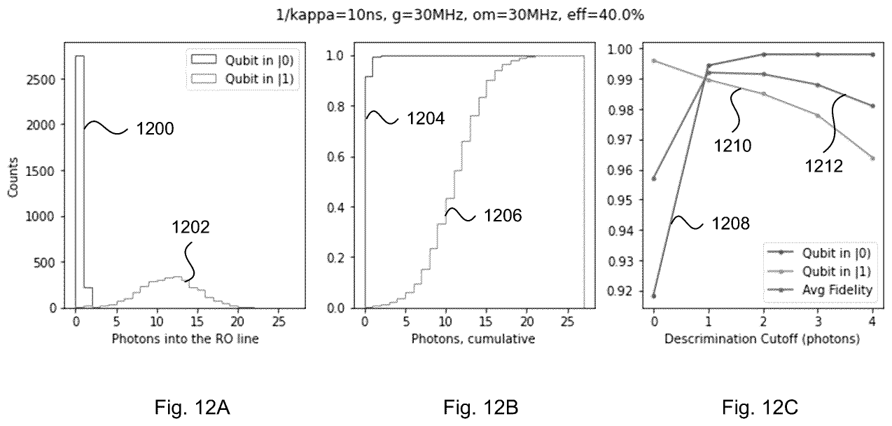

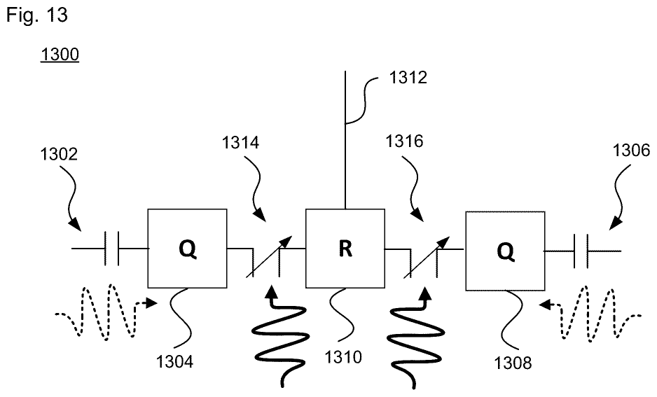

FIGS. 12A-C illustrate simulation results using the following criteria: 1/kappa=10 ns, g=30 MHz, om=30 MHz, and eff=40%. FIG. 12A plots counts (Y-axis) to photons in the readout line (X-axis) for both a qubit in |0 [symbol] (line 1200) and the qubit in |1 [symbol] (line 1202). FIG. 12B illustrates the cumulative number of photons (X-axis) when the qubit is in |0 [symbol] (line 1204), and when it is in |1 [symbol] (line 1206). These simulation results utilize example parameters chosen to broadly reflect what may be reasonable to build in superconducting architectures. Kappa is the coupling strength as described above, “g” is the coupling between the qubit and the resonator induced by the paradrive, “om” is the strength of a selective rabi drive on the qubit, and “eff” is the readout efficiency, which is the likelihood that a photon that enters the readout line is detected at the room temperature electronics. FIG. 13 illustrates the photon discrimination cutoff when the qubit is in |0 [symbol] (line 1208), when it is in |1 [symbol] (line 1210), and the average fidelity (line 1212). Here, it can be seen that in the simulation the readout fidelity approaches 99%.

Such results can be improved, for instance by improving selectivity, which can be done according to derivative removal by adiabatic gate (DRAG). Moreover, the parametric fluorescent readout approach may achieve even better results for qubits with larger anharmonicities/T1s. This may include the use of fluxonium superconducting qubits and/or L-shunted transmons.

FIG. 13 illustrates a system layout 1300 using dual paracouplers, which can be employed for an entangling readout. As shown, there is a first drive line 1302 into a first qubit 1304. There is a second drive line 1306 into a second qubit 1308. Resonator 1310 couples to readout line 1312 via a capacitor 310. The drive lines 1302 may include a capacitor (not illustrated). In this arrangement, a first paracoupler 1314 is arranged between the first qubit 1304 and the resonator 1310, and a second paracoupler 1316 is arranged between the second qubit 1308 and the resonator 1310. In this arrangement, the system can perform readout as before for each qubit 1304, 1308. Or the system could readout out both qubits simultaneously. Alternatively, the system could perform an “entangling measurement”, which measures a property of both qubits together, such as “are the qubit states the same or different” without learning the states themselves.

Thus, it can be seen that the use of a paracoupler can be beneficial in a microwave circuit-based quantum computing architecture. In contrast to a dispersive readout approach, a resonator does not have to drive the readout line, which can enable the architecture to use a simplified line configuration. Moreover, it does not matter if a qubit starts in |2 [symbol] , at it would look the same as in |1 [symbol] to the readout line. The paracoupler can also provide for natural leakage removal, as the selective paradrive causes qubit transition that move the qubit back to the computational states when it has leaked. Further, the paracoupler avoids readout transitions/ionization by preventing the buildup of energy during readout. This is because there would not be more than about 2 photons in the system at a time, so large energy transitions involving many photons would not be induced.

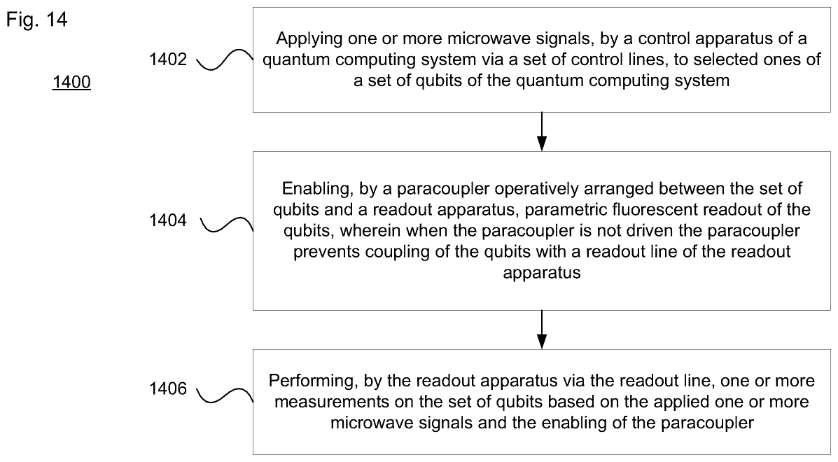

FIG. 14 illustrates an exemplary method 1400 in accordance with any of the above embodiments. In block 1402, the method includes applying one or more microwave signals, by a control apparatus of a quantum computing system via a set of control lines, to selected ones of a set of qubits of the quantum computing system. At block 1404, the method includes enabling, by a paracoupler operatively arranged between the set of qubits and a readout apparatus, parametric fluorescent readout of the qubits. When the paracoupler is not driven the paracoupler prevents coupling of the qubits with a readout line of the readout apparatus. At block 1406 the method includes performing, by the readout apparatus via the readout line, one or more measurements on the set of qubits based on the applied one or more microwave signals and the enabling of the paracoupler.

Unless otherwise stated, the foregoing alternative examples and embodiments are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the aspects described herein, as well as clauses phrased as “such as,” “including” and the like, should not be interpreted as limiting the subject matter of the claims to the specific examples or embodiments. Further, the same reference numbers in different drawings can identify the same or similar elements. The processes or other operations may be performed in a different order or simultaneously, unless expressly indicated otherwise herein.

1. A quantum computing system, comprising:
a set of qubits configured to be responsive to one or more microwave signals;
a control apparatus configured to apply the one or more microwave signals to the set of qubits, the control apparatus including a set of control lines configured to transmit the one or more microwave signals to corresponding ones of the set of qubits;
a readout apparatus configured to perform one or more measurements on the set of qubits, the readout apparatus including a readout line operatively coupled to the set of qubits; and
a paracoupler operatively arranged between the set of qubits and the readout apparatus, the paracoupler being configured to enable parametric fluorescent readout of the qubits via the readout apparatus, wherein when the paracoupler is not driven the paracoupler prevents coupling of the qubits with the readout line.

2. The quantum computing system of claim 1, further comprising a capacitor operatively arranged between the paracoupler and the readout line of the readout apparatus.

3. The quantum computing system of claim 2, wherein a frequency at the readout line is chosen in accordance with a frequency associated with the paracoupler and a frequency associated with one or more of the set of qubits.

4. The quantum computing system of claim 3, wherein the frequency at the readout line is in the microwave band.

5. The quantum computing system of claim 2, wherein the capacitor provides a selected kappa level.

6. The quantum computing system of claim 2, further comprising a resonator operatively arranged between the paracoupler and the capacitor.

7. The quantum computing system of claim 6, wherein:
the resonator has an operating frequency; and
the paracoupler is an LR parametric drive configured to couple a first qubit frequency to the operating frequency of the resonator and to not couple a second qubit frequency to the operating frequency of the resonator.

8. The quantum computing system of claim 1, further comprising a resonator operatively arranged between the paracoupler and the readout line of the readout apparatus.

9. The quantum computing system of claim 8, wherein the paracoupler is a first paracoupler, and the quantum computing apparatus further includes a second paracoupler operatively arranged between resonator and the readout line of the readout apparatus.

10. The quantum computing system of claim 1, wherein the one or more microwave signals comprise a set of microwave control pulses.

11. The quantum computing system of claim 10, wherein one or more of the set of microwave control pulses comprise a-pulse, which acts to exchange populations of quantum states in the one or more qubits.

12. A quantum computing method, comprising:
applying one or more microwave signals, by a control apparatus of a quantum computing system via a set of control lines, to selected ones of a set of qubits of the quantum computing system;
enabling, by a paracoupler operatively arranged between the set of qubits and a readout apparatus, parametric fluorescent readout of the qubits, wherein when the paracoupler is not driven the paracoupler prevents coupling of the qubits with a readout line of the readout apparatus; and
performing, by the readout apparatus via the readout line, one or more measurements on the set of qubits based on the applied one or more microwave signals and the enabling of the paracoupler.

13. The quantum computing method of claim 12, wherein the one or more microwave signals comprise a set of microwave control pulses.

14. The quantum computing method of claim 13, wherein one or more of the set of microwave control pulses comprise a x-pulse, which acts to exchange populations of quantum states in the one or more qubits.

15. The quantum computing method of claim 12, wherein a capacitor is operatively arranged between the paracoupler and the readout line of the readout apparatus, the capacitor provides a selected kappa level.

16. The quantum computing method of claim 12, wherein a frequency at the readout line is chosen in accordance with a frequency associated with the paracoupler and a frequency associated with one or more of the set of qubits.

17. The quantum computing method of claim 16, wherein the frequency at the readout line is in the microwave band.

18. The quantum computing method of claim 12, wherein:
a capacitor is operatively arranged between the paracoupler and the readout line of the readout apparatus;
a resonator is operatively arranged between the paracoupler and the capacitor, the resonator having an operating frequency; and
the paracoupler is an LR parametric drive configured to couple a first qubit frequency to the operating frequency of the resonator and to not couple a second qubit frequency to the operating frequency of the resonator.

19. The quantum computing method of claim 12, wherein a resonator is operatively arranged between the paracoupler and the readout line of the readout apparatus.

20. The quantum computing method of claim 19, wherein the paracoupler is a first paracoupler, and the quantum computing apparatus further includes a second paracoupler operatively arranged between resonator and the readout line of the readout apparatus.
